(19) United States
(12) Patent Application Publication
(10) Pub. No.: US 2009/0037420 A1
(43) Pub. Date: Feb. 5, 2009

(54) DEVICE WITH STORAGE MEDIUM AND METHOD OF OPERATING THE DEVICE

(75) Inventors: Jozef P. Van Gassel, Eindhoven (NL); Ruud Wijnands, Egchel (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,098

(22) PCT Filed: Oct. 10, 2005
(86) PCT No.: PCT/IB05/53309

§ 371 Date: Apr. 12, 2007

(30) Foreign Application Priority Data
Oct. 12, 2004 (GB) 0422570.2

(51) Int. Cl. G11B 5/82; G06F 17/30

(52) U.S. Cl. 707/10; 360/135; 707/E17.001

(57) ABSTRACT

A device comprises a first storage medium, input/output architecture, a second storage medium, and a processor. The processor is arranged, in response to a request to access a file stored on the first storage medium, to recall the file from the first storage medium at substantially the data rate of the file, to transmit a first portion of the file, and to store a second portion of the file in the second storage medium.

This invention relates to a device that includes a storage medium and to a method of operating the device.

A very large number of electronic devices are provided with one or more storage mediums for storing data and programs. The storage medium, which can be optical, magnetic or solid state, is in many devices of great importance. In the operation of the storage medium, a variety of parameters, such as size, speed and energy consumption of the medium, are critical. The type of device, and the likely environment in which it will be used, determine which of these parameters are most important.

One type of storage media, known as hard disk drives (HDD), is well known and used throughout the computing world. Such HDDs are also being incorporated in portable electronic devices such as multimedia devices like mobile phones and personal digital assistants (pdas). HDDs have the advantage that a relatively large amount of data can be stored on the storage medium, with fast read/write capabilities. However storage media such as these are known to be intensive in their consumption of power, as a motor is required to rotate the hard disk, which consumes a large amount of power in comparison to that used by solid state devices. In particular, when the HDD moves from an inactive to active state, a relatively large amount of power is consumed in order to begin rotation of the disk.

U.S. Pat. No. 6,512,652 discloses a power saving method and apparatus for computer disk drives. The power saving method and apparatus maintains an operational or near-operational state for computer memory disk drives. A microprocessor implements microcode instructions to determine if a disk drive is inactive. This is done by checking a control unit through an interface to see if any files are currently opened or data is being transferred by the disk device. If no files are opened and/or no data transfers are occurring, the drive is considered inactive. If the inactive period continues for a period of time that is greater than a predetermined reference activity level, then actions are taken to reduce the rotational velocity of the drive spindle motor to its lowest operational level, or just below the lowest operational level without stopping the disk. The spindle motor is accessed by the microprocessor through a spindle motor control unit. In the case of a constant linear velocity disk drive, the spindle motor is indirectly controlled by the microprocessor sending a message to an actuator to move a data head to a track that is near the outer periphery of the disk medium. In order to maintain a constant linear velocity, the spindle control slows the angular velocity of the motor resulting in a reduction of power consumed. When it is necessary to access data again, the drive enters an active state and the head is moved by a microprocessor “seek” command. In the case of a constant angular velocity disk drive having selectable speeds, the microprocessor controls the motor speed directly. The microprocessor, upon determining that the disk has been inactive for a predetermined threshold period, selects a constant speed that is the lowest operation speed available. This results in a power saving mode being implemented for the disk drive The drive is returned to normal operational speed by a microprocessor “seek” command. For further savings, the motor is stopped or “spun down” when left inactive for a longer period of time.

The solution described in the above patent is a relatively straightforward power saving method for a hard disk drive. By monitoring the use of files and data transfer, the apparatus is able to return the disk drive to idle, when the apparatus perceives there is no demand for memory recall from the hard disk. However this solution does not minimise power consumption in situations where data is being recalled from the hard disk.

United States Patent Application Publication US 2003/0004948 discloses a system and method for retrieving data from disk in a network environment. The system and method of retrieving data from a disk includes determining the network transfer rate of a network connection between a client and a server. A first portion of the requested data is retrieved from the disk responsive to a data request received by the server from the client via a network connection and transmission of the first portion of data to the client via the network is initiated. The time required to transmit the first portion of data to the client is calculated based upon the network transfer rate and a determination of when to retrieve a subsequent portion of the requested data from disk is made based, in part, on whether the calculated time is expired. The determination of when to retrieve subsequent portions of data from disk may be further based on a desire to minimize a system parameter such as memory usage or disk energy consumption and heat dissipation.

The solution of the above patent application is essentially to reduce the speed at which the disk drive is to operate (which will correspond to a data transfer rate), to the speed of the network connection. This will ensure a steady speed for the rotation of the disk drive and therefore reduce starting and stopping of the drive. However, this method will only cover a relatively small set of circumstances, as it will not work in situations where the network speed is unavailable, nor will it work in situations where the network speed is irrelevant, as will occur in situations that use particular network protocols that are packet based and using “best effort” type transmission systems. These protocols will have effective speeds that are much lower than the speed of the network connection.

It is therefore an object of the invention, to improve upon the known art.

According to a first aspect of the present invention, there is provided a device comprising a first storage medium, input/output architecture, a second storage medium, and a processor, the processor being arranged, in response to a request to access a file stored on the first storage medium, to recall said file from the first storage medium at substantially the data rate of said file, to transmit a first portion of said file, and to store a second portion of said file in the second storage medium.

According to a second aspect of the present invention, there is provided a method of operating a device, comprising receiving a request to access a file stored on a first storage medium, recalling said file from the first storage medium at substantially the data rate of said file, transmitting a first portion of said file, and storing a second portion of said file in a second storage medium.

According to a third aspect of the present invention, there is provided a computer program product comprising a computer readable medium containing computer executable instructions for receiving a request to access a file stored on a first storage medium, recalling said file from the first storage medium at substantially the data rate of said file, transmitting a first portion of said file, and storing a second portion of said file in a second storage medium.

Owing to the invention, it is possible to operate a device that has a first storage medium, with maximum energy efficiency. When the device receives a request for a file that is stored on the first storage medium, it streams that file from the first storage medium at the data rate of the file, regardless of whether the request for the file is a request for it to be streamed. Any portion of the file that is not needed immediately is stored on a second storage medium. Typically the first storage medium is a hard disk drive that is most energy efficient when it is running at a constant rate rather than starting and stopping, and the second storage medium is a solid state memory device.

There is no requirement for any knowledge by the device of circumstances outside the device, such as network speed and/or latency, nor will it matter what type of protocol is requesting the file from the device, as any portion of the file that has not yet been transmitted will be stored in the second storage medium, being the solid state memory. Therefore when so called “best effort” protocols are being used, during any period when packets are not being requested, data is effectively being streamed from the hard disk drive to the solid state memory, in preparation for further requests for packets, which will then be transmitted from the solid state memory.

Future mobile multimedia devices require being capable of handling both real-time (i.e. streaming audio and video content) as well as best effort (e.g. still pictures, database access and web content) data transfers from their local storage in a mixed way. The local storage of such devices is most likely a Hard Disk Drive (HDD) but could also be a Small Form Factor Optical (SFFO) drive. Since this data will often be accessed remotely via HTTP (i.e. the mobile device acts as a web server), it is not always clear whether the other end intends to access the data in a real-time or best effort mode. The latter is especially true for protocols such as Universal Plug and Play (UPnP), which is based for a large part on web based technology. Usually best effort and real-time requests will be received in a mixed way.

In the case where a UPnP MediaServer will use HTTP as a protocol to transfer data, since HTTP is a pull transfer, the server has no control over when the remote client will read blocks (i.e. small parts of the requested content) of data. Since no explicit stream is set up and no admission control takes place, this type of best effort request might heavily interfere with the energy saving disk scheduling. This will be caused by the fact that best effort requests might be handled in periods when the device has switched the HDD off to save energy. Having to spin up the HDD, execute the request and spinning the HDD down again will be a waste of energy. The present invention provides a method to prevent uncontrolled spin ups of the drive on these occasions.

Advantageously, the input/output architecture comprises a transceiver, and the device receives the request to access a file stored on the first storage medium, wirelessly, from a second device. The devices are typically mobile phones, or similar multimedia devices, that are in a wireless network, with push and pull data connections between them. The method also works if the devices are in wired communication, although in most such situations, power consumption is not a critical issue.

Preferably, the processor is further arranged, prior to recalling said file from the first storage medium, to access the metadata of said file, to ascertain the data rate of said file. This is the simplest method for the device to find out the data rate of the file for which it has received a request.

Ideally, the processor is further arranged, upon request, to transmit the second portion of said file. The second portion of the file, which is stored in the solid state memory, the second storage medium, it available on request for onward transmission.

Embodiments of the present invention will now be described, by way of example only, with reference to the accompanying drawings, in which:—

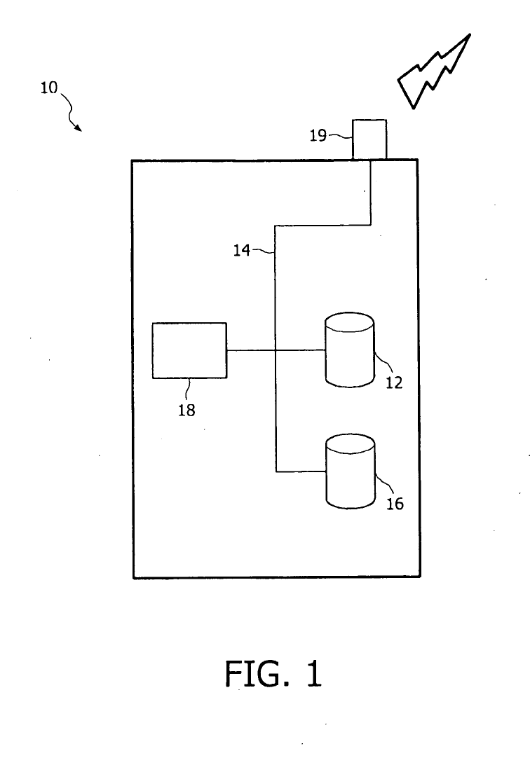

FIG. 1 is a schematic view of a device including two storage mediums,

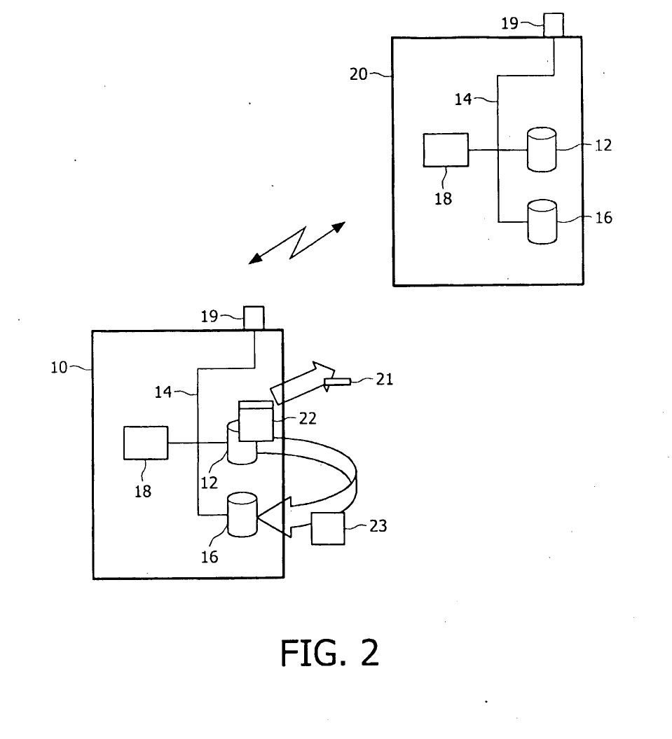

FIG. 2 is schematic view of the device of FIG. 1, in communication with a second device, and

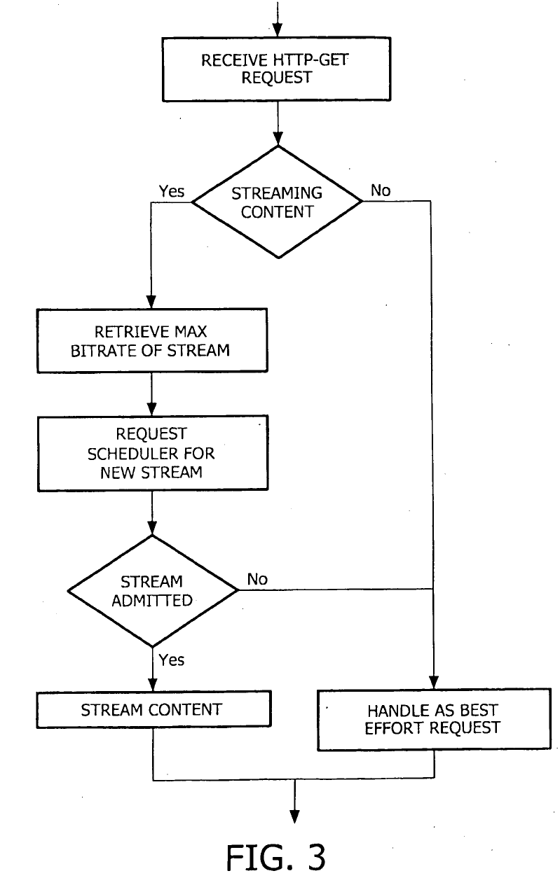

FIG. 3 is a flowchart of a method of operating the device of FIG. 1.

FIG. 1 shows a device 10, which comprises a first storage medium 12, input/output architecture 14, a second storage medium 16, and a processor 18. The input/output architecture 14 also includes a transceiver 19 for sending and receiving wireless communications. The first storage medium 12 is a hard disk drive, which has a relatively large storage capacity, and the second storage medium 16 is a solid state memory, which is relatively small, but requires minimal power to operate. All of the substantial memory use is channelled through the first storage medium 12, which will contain the files and executables for operating the device 10, and all of the user's data and files such as messages and pictures. The second storage medium 16 is effectively a caching memory used on demand.

The device 10 is a multimedia mobile phone 10, and also includes a number of components that are not shown, such as a display, a user interface (which may be part of the display), and a power source. The mobile phone 10 will typically be of the type that can participate in the third generation mobile telephony services such as UMTS and also has one or more short range wireless functionalities, such as Bluetooth and/or WiFi (IEEE 802.11b).

Mobile telephones such as the device 10 shown in FIG. 1, at present can access the Internet via the wide area wireless network (such as UMTS) in which they participate, and can send and receive digital pictures and can also receive video files and real time streamed video. As technology advances and processing power increases and storage media become cheaper, larger and more efficient, mobile multimedia devices such as the phone 10 will also be able to transmit video files on demand. This might occur if a first device in short range contact with a second device requests a video file to be transmitted to the first device.

The device 10 could also be a mobile audio/video server 10 participating in a local or wide area wireless network. In a network using such a server 10, mobile devices such as mobile phones will be in communication with the server 10, and will transmit requests for files to be sent by the server, to that device making the request.

FIG. 2 shows two such mobile multimedia devices 10 and 20 in communication. This communication could be via a short range wireless link, or could be over a wide area network, such as the UMTS network. The two devices 10 and 20 could be in the cell of the cellular network of the UMTS system, or they could be located in separate cells. Communication is triggered by the second device 20 requesting a file 22, such as a short video file, which is stored by the first device 10. The request from the device 20 will typically be using the HTTP protocol (or the less common RTP protocol), which is ubiquitous for communication in relation to the Internet. The device 10 receives the request to access the file 22 stored on the first storage medium 12, wirelessly, from the second device 20.

Once communication has been initiated, the processor 18 of the mobile device 10 is arranged, in response to the request to access the file 22 stored on the first storage medium 12, to recall the file 22 from the first storage medium 12 at substantially the data rate of the file 22. The processor 18 is arranged, prior to recalling the file 22 from the first storage medium 12, to access metadata of the file 22, to ascertain the data rate of the file 22. The data rate, in this context, is the rate that was used when the file 22 was originally created and corresponds to the bandwidth required to be able to stream the file, that is to be able to simultaneously read and render the contents of the file without requiring buffering.

The processor 18 is arranged to transmit a first portion 21 of the file 22, and to store a second portion 23 of the file 22 in the second storage medium 16. The device 10 transmits the first portion 21 of the file 22 back to the requesting device 20 and streams the remainder, at the data rate of the file 22, to the solid state memory 16. As further requests are received from the device 20 for further portions of the file 22, the processor 18 is further arranged, upon request, to transmit the second portion 23 of the file 22.

The first portion 21, which is transmitted by the device 10, may be routed via the second storage medium 16. In this way, the processor 18 is controlling the operation of the first storage device 12 to effectively read the file 22 to the second storage medium 16 at the data rate of the file 22, with the portions of the file 22 being transmitted as the second device 20 requests them. Of course in virtually all practical situations, the first portion 21 of the file 22 will be transmitted immediately, as the request from the second device 20 which triggers the recalling of the file 22 from the first storage medium will be a request for that first portion 21 of the file 22.

Effectively extra functionality is added to the disk scheduling algorithm to handle pull based streaming (e.g. via HTTP) in a more efficient way based on a priori application knowledge. This will prevent the HDD from being woken up from the power down or standby state. As soon as the mobile server gets a request for streaming content (i.e. a audio or data file) the disk scheduler will not treat it as a best effort request but as if a request for real-time streaming.

The mobile server can make this decision on its own because it has knowledge on the characteristics of the file (in the form of metadata). For instance it can use the MIME type to decide whether the content should be streamed or not. The bit rate of the streaming content is stored somewhere in the metadata database or is embedded in the file stored on the medium. Subsequently a stream from the storage medium to the network will be initiated with the aforementioned characteristics. The method is illustrated in more detail in the flow chart of FIG. 3.

FIG. 3 illustrates an example of how this could work in practice. The mobile server receives a request from the client in the form of a HTTP request. Based on the MIME type or file extension in the HTTP request the server can identify whether the requested content is streaming content. If this is not the case, the request is handled in the normal best effort way. In the case that streaming content is requested, the server resolves the URL in the HTTP header and queries the associated metadata to retrieve the bit-rate of the streaming content. The bit rate is subsequently used for the HDD scheduling algorithm to control the buffer filling to make sure that the streaming content is available at the desired bit rate. If the real-time guarantees cannot be met, the file is handled in a best effort way. If the stream can be served at the requested rate the buffer is filled and streaming can start.

It should be understood that the method is not limited to HTTP but also works for other (best effort) protocols that are streaming unaware. Using this method, streaming content being retrieved via a pull mechanism is actually being delivered using a push model (where a stream was explicitly scheduled).

Via this method, the benefits of the power saving mobile scheduling are maintained while the remote client (the mobile device requesting the file) will not be aware of the fact that the data is actually pushed instead of pulled via the scheduler buffer. For the client it appears as if it is retrieving the data via a pull mechanism.

The disk scheduler fills a scheduler buffer (the second storage medium) in a single burst in order to be able to power down the hard disk drive and save energy. The HTTP client reads (pulls) data from this scheduler buffer whenever it wants to. This way, the scheduler buffer is used to decouple the push and pull mechanisms.

If the HTTP client reads faster than the actual bit rate of the stream the energy saving strategy would get disrupted. This would either occur at the start of the request for the file (in order to fill the buffer at the other side of the connection) or in the situation that the data is being pulled at maximum possible speed (in which cases the disk has to wake up from the power down state anyway). This method is also power friendly (due to its bursty nature).

The big advantage of the proposed method is that there will be no unexpected best effort accesses to the disk when streaming content is being pulled from server to the client over a networked connection. This way the energy saving strategy is completely unaffected. This eliminates the penalty of extra power consumption or performance because of unexpected disk accesses.

1. A device (10) comprising a first storage medium (12), input/output architecture (14, 19), a second storage medium (16), and a processor (18), the processor (18) being arranged, in response to a request to access a file (22) stored on the first storage medium (12), to recall said file (22) from the first storage medium (12) at substantially the data rate of said file (22), to transmit a first portion (21) of said file (22), and to store a second portion (23) of said file (22) in the second storage medium (16).

2. A device according to claim 1, wherein the input/output architecture (14, 19) comprises a transceiver (19).

3. A device according to claim 2, wherein the device (10) receives the request to access said file (22) stored on the first storage medium (12), wirelessly, from a second device (20).

4. A device according to claim 1, wherein the processor (18) is further arranged, prior to recalling said file (22) from the first storage medium (12), to access metadata of said file (22), to ascertain the data rate of said file (22).

5. A device according to claim 1, wherein the first storage medium (12) comprises a hard disk drive (12).

6. A device according to claim 1, wherein the second storage medium (16) comprises a solid state memory (16).

7. A device according to claim 1, wherein the processor (18) is further arranged, upon request, to transmit the second portion (23) of said file (22).

8. A device according to claim 1, wherein the device (10) comprises a mobile phone (10).

9. A device according to claim 1, wherein the device comprises a mobile audio/video server.

10. A method of operating a device, comprising receiving a request to access a file (22) stored on a first storage medium (12), recalling said file (22) from the first storage medium (12) at substantially the data rate of said file (22), transmitting a first portion (21) of said file (22), and storing a second portion (23) of said file (22) in a second storage medium (16).

11. A method according to claim 10, wherein the request to access said file (22) stored on the first storage medium (12) is received via a transceiver (19).

12. A method according to claim 11, wherein the transceiver (19) receives the request to access said file (22) stored on the first storage medium (12), wirelessly, from a remote device (20).

13. A method according to claim 10, and further comprising, prior to recalling said file (22) from the first storage medium (12), accessing metadata of said file (22), to ascertain the data rate of said file (22).

14. A method according to claim 10, wherein the first storage medium (12) comprises a hard disk drive (12).

15. A method according to claim 10, wherein the second storage medium (16) comprises a solid state memory (16).

16. A method according to claim 10, and further comprising, upon request, transmitting the second portion (23) of said file (22).

17. A method according to claim 10, wherein the method is executed by a processor (18), forming part of a mobile phone (10).

18. A method according to claim 10, wherein the method is executed by a processor (18), forming part of a mobile audio/video server.

19. A computer program product comprising a computer readable medium containing computer executable instructions for receiving a request to access a file (22) stored on a first storage medium (12), recalling said file (22) from the first storage medium (12) at substantially the data rate of said file (22), transmitting a first portion (21) of said file (22), and storing a second portion (23) of said file (22) in a second storage medium (16).

20. A computer program product according to claim 19, wherein the request to access said file (22) stored on the first storage medium (12) is received via a transceiver (19).

21. A computer program product according to claim 20, wherein the transceiver (19) receives the request to access said file (22) stored on the first storage medium (12), wirelessly, from a remote device (20).

22. A computer program product according to claim 19, and further comprising instructions, prior to recalling said file (22) from the first storage medium (12), for accessing metadata of said file (22), to ascertain the data rate of said file (22).

23. A computer program product according to claim 19, wherein the first storage medium (12) comprises a hard disk drive (12).

24. A computer program product according to claim 19, wherein the second storage medium (16) comprises a solid state memory (16).

25. A computer program product according to claim 19, and further comprising instructions, upon request, for transmitting the second portion (23) of said file (22).

26. A computer program product according to claim 19, wherein the computer program product is executed by a processor (18), forming part of a mobile phone (10).

27. A computer program product according to claim 19, wherein the computer program product is executed by a processor (18), forming part of a mobile audio/video server.
